(19) United States
(12) Patent Application Publication
(10) Pub. No.: US 2001/0029192 A1
(43) Pub. Date: Oct. 11, 2001

(54) Cellular phone having an audio player

(76) Inventor: Seung-Hwan Oh, Seoul (KR)

Correspondence Address: HARNESS, DICKEY & PIERCE, PLC, P.O. BOX 828, BLOOMFIELD HILLS, MI, 48303, US

(21) Appl. No.: 09/827,585

(22) Filed: Apr. 6, 2001

(30) Foreign Application Priority Data
Apr. 7, 2000 (KR) 00-18171
Jul. 4, 2000 (KR) P 2000-18169

(51) Int. Cl. H04M 1/00

(52) U.S. Cl. 455/556; 455/557; 455/550

(57) ABSTRACT

Disclosed is to a cellular phone which is compatible with an MP3 player, which is detachably inserted to a battery of the cellular phone, and can be used for an audio player by connecting to the battery with the MP3 player, so that it is convenient for a user to use the MP3 player without the increasing weight and the size of a main body to the cellular phone.

### BACKGROUND OF THE INVENTION

1. Field of the invention

The present invention relates to a cellular phone having an audio player, and more particularly, to a cellular phone which is compatible with an MP3 player, which is detachably inserted to a battery of the cellular phone, and can be used for an audio player by connecting to the battery with the MP3 player, so that it is convenient for a user to use the MP3 player without the increasing weight and the size of a main body to the cellular phone.

2. Prior Art

Various audio/video reproducing devices have been devised according to the development of a memory technology capable of storing electric signals.

A CD and an MP3 flash memory card are becoming widely used as storing means of audio data.

Audio information stored in the MP3 flash memory card is reproduced by an MP3 player. The MP3 player is an audio reproducing device which has enough compression rate so that its size can be greatly reduced. Also, the MP3 player enables users to freely collect and use only desired songs and provides an excellent sound quality almost approaching the original sound.

The prior art discloses various types of MP3 players, which reproduce audio information stored in the MP3 flash memory card, since it has been explosively used as an audio reproducing device.

One known device uses a connector protruding from a cellular phone or a long signal transmission line in order to connect the cellular phone and the MP3 player. However, such device is provided separately from the cellular phone, so a user has to carry the connector or the long signal transmission line. Therefore, the line or the connector causes inconvenience for a user to carry it.

In the meantime, another known device is an MP3 player which is integrally provided with a main body of a cellular phone. However, the above device has a disadvantage that weight and volume of the main body of the cellular phone increases and an internal structure thereof is complicated.

### SUMMARY OF THE INVENTION

Accordingly, it is an object of the prevent invention to provide a structure of a battery capable of selectively detaching an audio player such as an MP3 player from a cellular phone.

It is another object of the prevent invention to provide a cellular phone having an audio player which does not require any connecting means nor increases the weight of the main body of the cellular phone.

In order to achieve the above object, a cellular phone having an audio player comprises a main body having a visual display device for displaying operating information thereof and function keys for executing operator commands; a battery connected to the main body for supplying power to the cellular phone, the battery having an insertion space having a shape which corresponds to an audio player to be inserted therein; the audio player detachably inserted within the insertion space for reproducing audio information and controlled by an operation of the function keys, power for operating the audio player supplied from the battery; and an output part for outputting sound reproduced by the audio player.

The insertion space is preferably open toward the center portion of the rear side of the main body.

The audio player may be an MP3 player. The MP3 player has a memory card to be inserted into the inside thereof for storing the audio information. The audio information is downloaded through the main body of the cellular phone and is stored in the memory card.

The output part may be a speaker integrally built-in inside the main body. The output part can be selected from the group consisting of an earphone, headphones, and a neck phone disposed on the rear of the neck of a user.

The visual display device displays information pertaining to playing audio information.

The cellular phone may further comprise a microphone operatively connected to the audio player for collecting external sound.

### BRIEF DESCRIPTION OF THE DRAWINGS

The above object and other advantages of the present invention will become more apparent by describing in detail the preferred embodiment of the present invention with reference to the attached drawings, in which:

FIG. 1 is a schematic view for showing a structure of a cellular phone having an MP3 player according to an embodiment of the present invention;

FIG. 2 is a schematic view for showing an embodiment of a structure of the function keys of the cellular phone of FIG. 1; and

FIG. 3 is a block diagram for showing a flow of a signal of the cellular phone of FIG. 1.

### DETAILED DESCRIPTION OF THE PREFERRED EMBODIMENT

Hereinafter, concrete characteristics and advantages of the present invention will become more apparent with a detailed description of a preferred embodiment with reference to the accompanying drawings.

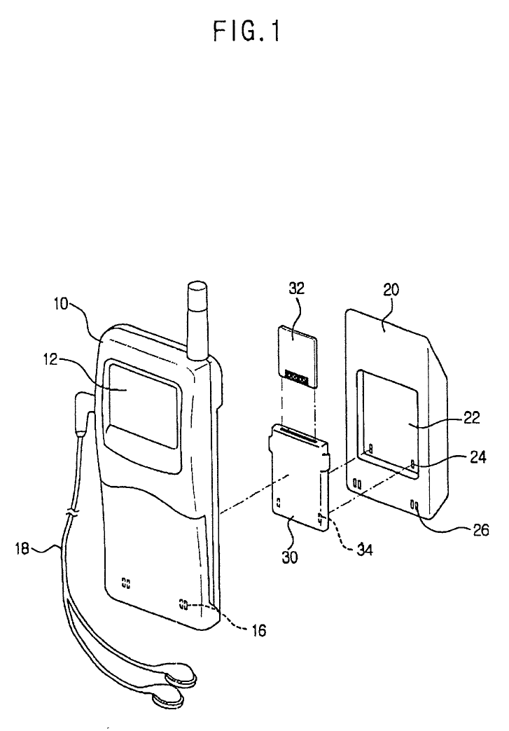

FIG. 1 is a schematic view for showing a structure of a cellular phone having an audio player according to an embodiment of the present invention.

As shown in FIG. 1, the cellular phone having an MP3 player according to an embodiment of this invention includes a main body 10, a battery 20, an MP3 player 30, and an earphone 18.

The main body 10 has function keys 14 and a visual display device 12 for displaying time, date, information pertaining to power availability, information pertaining to memory availability, etc. The function keys 14 can be used for control buttons for controlling the operation of the MP3 player 30. The main body 10 can be provided with a visual display device controller for controlling the visual display device 12.

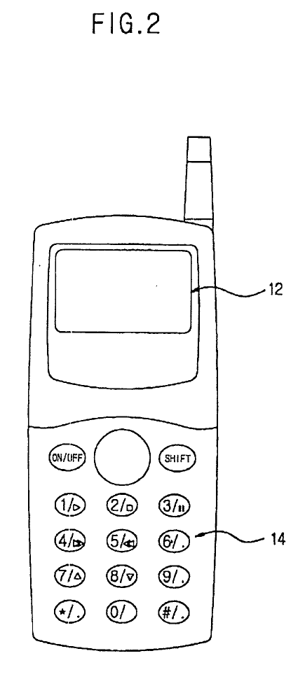

FIG. 2 is a schematic view for showing an embodiment of a structure of function keys of the cellular phone of FIG. 1.

As shown in FIG. 2, functions for an operation of the MP3 player 30 can be allotted to the function keys 14 of the main body 10 respectively. Keys for operation of the MP3 player 30, for example, may comprise ON/OFF, PLAY, FF, STOP, REW, SHIFT, PAUSE, VOLUME, etc. and can be determined by a manufacturer according to various conditions.

The function keys 14 of the main body 10 control the operation of the MP3 player 30 and may control the volume produced by the MP3 player 30.

The visual display device 12 can be designed to serve by displaying visual information such as, but not limited to, a title of music, a name of performer or singer, and music performance time. The visual display device 12 can be, for example, a light emitting diode display (LEDD) or a liquid crystal display (LCD).

The battery 20 is connected to the main body 10 and serves to supply power to the cellular phone. The battery 20 has an insertion space 22 for receiving the MP3 player 30. Therefore, the shape of the insertion space 22 corresponds to the shape of the MP3 player 30. The insertion space is preferably open toward the center portion of the rear side of the main body 10.

The MP3 player 30 has a memory card 32, which is inserted therein, and reproduces the digital audio information. Also, the MP3 player 30 includes a microprocessor for controlling the operation of the MP3 player 30, a decoder for decoding the digital audio information stored in the memory card 32, and a D/A converter for converting digital audio information to analogue audio information.

The digital audio information may be downloaded from the computer through a communicator connected to the cellular phone and then stored in the memory card 32. Also, the digital audio information may be downloaded through the main body 10 and then stored in the memory card 32.

The MP3 player 30 is detachably inserted into the insertion space 22. The battery 20 may supply power to the MP3 player 30.

Within the embodiment of the present invention, the MP3 player 30 is preferably adapted to reproduce audio data. However, the MP3 player 30 can be substituted with an audio data reproducing device which reproduces MP4, AT & T, a2b, Liquid Audio, Real Audio, SDMI and/or any other existing or developable audio data compressed format.

The output part outputs sound reproduced by the MP3 player 30. The output part can be a speaker integrally built-in inside the main body 10. Further, the output part can be an earphone, headphones or a neck phone disposed at the back of the neck of a user, etc. The earphone, etc. is connected to an output port formed at a portion of the main body 10 and used for listening to music.

Meanwhile, a second connector 24 and a fourth connector 34 are provided at the wall of the insertion space 22 of the battery 20 and at outer surface of the MP3 player 30 respectively to electrically connect the battery 20 and the MP3 player 30. Also, a first connector 16 and a third connector 26 are provided at the rear side of the main body 10 and at a portion of the battery 20 respectively to transmit electric signals generated by the MP3 player 30 to the main body 10.

The cellular phone having an audio player according to the present invention further comprises a microphone operatively connected to the audio player for collecting external sound. The collected external sound is stored in the memory card 32 through the micro processor.

Hereinafter, the operation of the cellular phone having an MP3 player according to the present invention will be described.

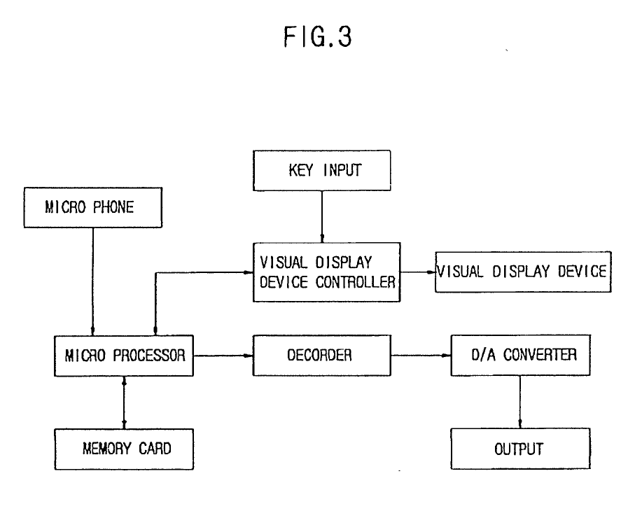

FIG. 3 is a block diagram for showing a flow of a signal of the cellular phone of FIG. 1.

As a starting point, when a user intends to listen to music, the user inserts the memory card 32 storing audio information into the MP3 player 30. The user inserts the MP3 player 30 with the memory card 32 into the insertion space 22 of the battery 200 and then connects the battery 200 with the MP3 player 30 to the rear side of the main body 10.

As shown in FIG. 3, when a user pushes the function keys 14, for example a play key, the visual display device 12 displays predetermined information by a control of the visual display device controller. At that time, the microprocessor receives the digital audio information from the memory card 32 and then transmits it to the decoder. The digital audio information is decoded by the decoder and then reproduced for the output part such as the earphone 18 through the D/A converter.

If somebody phones when you are listening to music from the MP3 player 30, the signal generated from the MP3 player 30 is cut off and then the signal transmitted from the main body 10 of the cellular phone is transmitted to the output part such as the earphone 18. Thus, the user can talk to the caller. Therefore, the structure of the main body 10 of the cellular phone does not change even though the MP3 player 30 is inserted within the battery 20.

As described above, the cellular phone according to the present invention has the battery of the cellular phone having an MP3 player integrally provided within the insertion space thereof, so that it is convenient for a user to carry it because it is compact.

Also, a user can easily use an MP3 player while using a cellular phone without increasing weight and volume of the main body of the cellular phone.

Also, a user can use a normal battery without the insertion space if he does not need to use an MP3 player because the MP3 player can be selectively mounted on the battery.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claim are therefore intended to be embraced therein.

What is claimed is:

1. A cellular phone having an audio player comprising:
a main body having a visual display device for displaying operating information thereof and function keys for executing operator commands;
a battery connected to the main body for supplying power to the cellular phone, the battery having an insertion space having a shape which corresponds to an audio player to be inserted therein;
the audio player detachably inserted within the insertion space for reproducing audio information and controlled by an operation of the function keys, power for operating the audio player supplied by the battery; and
an output part for outputting sound reproduced by the audio player.

2. A cellular phone having an audio player as claimed in claim 1, wherein the insertion space is open toward the center portion of the rear side of the main body.

3. A cellular phone having an audio player as claimed in claim 1, wherein the audio player is an MP3 player.

4. A cellular phone having an audio player as claimed in claim 3, wherein the MP3 player has a memory card to be inserted inside thereof for storing the audio information.

5. A cellular phone having an audio player as claimed in claim 4, wherein the audio information is downloaded through the main body of the cellular phone and is stored in the memory card.

6. A cellular phone having an audio player as claimed in claim 1, wherein the output part is a speaker integrally built-in inside the main body.

7. A cellular phone having an audio player as claimed in claim 1, wherein the output part is selected from the group consisting of an earphone, headphones, and a neck phone disposed at the back of the neck of a user.

8. A cellular phone having an audio player as claimed in claim 1, wherein the visual display device displays information pertaining to playing audio information.

9. A cellular phone having an audio player as claimed in claim 1, further comprising a microphone operatively connected to the audio player for collecting external sound.
